(19) United States
(12) Patent Application Publication
(10) Pub. No.: US 2024/0101094 A1
(43) Pub. Date: Mar. 28, 2024

(54) ELECTROMECHANICALLY DRIVABLE BRAKE PRESSURE GENERATOR

(71) Applicant: Robert Bosch GmbH, Stuttgart (DE)

(72) Inventors: Claus Oehler, Karlsruhe (DE); Mark Boehm, Lehrensteinsfeld (DE)

(21) Appl. No.: 17/769,192

(22) PCT Filed: Oct. 28, 2020
(86) PCT No.: PCT/EP2020/080284

§ 371 Date: Apr. 14, 2022

(30) Foreign Application Priority Data
Nov. 19, 2019 (DE) 10 2019 217 842.1

(51) Int. Cl. B60T 13/74; B60T 13/16; F16H 55/06; F16H 57/023

(52) U.S. Cl. CPC B60T 13/745; B60T 13/168; F16H 55/06; F16H 57/023; F16H 2057/02017

(57) ABSTRACT

An electromechanically drivable brake pressure generator for a hydraulic braking system of a vehicle. The brake pressure generator includes a spindle drive unit for converting a drive-side rotary motion into a translatory motion for the actuation of a piston of a hydraulic piston/cylinder unit, a planetary gear, which is connected to an electric drive motor, being situated between the spindle drive unit and an electric drive motor at whose output-side planet carrier axle a spur gear is attached, via which the spindle drive unit is drivable. The spur gear is mounted via a first bearing, which is situated between the spur gear and the planetary gear, and via a second bearing, which is situated on an axial side of the spur gear situated opposite the first bearing.

### FIELD

The present invention relates to an electromechanically drivable brake pressure generator for a hydraulic braking system of a vehicle, including a spindle drive unit for converting a drive-side rotary motion into a translatory motion for the actuation of a piston of a hydraulic piston/cylinder unit, a planetary gear which is connected to an electric drive motor and at whose output-side planet carrier axle a spur gear is attached, via which the spindle drive unit is drivable, being situated between the spindle drive unit and an electric drive motor. The present invention furthermore relates to a vehicle which includes such an electromechanically drivable brake pressure generator.

### BACKGROUND INFORMATION

Alternative brake pressure buildup devices are needed for future drive concepts of motor vehicles since a vacuum is no longer available to operate a conventional vacuum brake booster. For this purpose, the electromechanical brake pressure generators of interest here were developed.

In an electromechanical brake pressure generator of the type of interest here, the braking force at the piston/cylinder unit is generated with the aid of an electric motor or another suitable electric drive. Such brake pressure generators may not only be used to provide an auxiliary force, but in so-called brake by wire systems also to single-handedly generate the brake actuating force. Electromechanical brake pressure generators are thus of advantage, in particular, with respect to autonomous driving.

According to the conventional related art regarding such electromechanical brake pressure generators, the manually carried out pedal travel is measured via an electronic pedal travel sensor during the actuation of the brake pedal and forwarded to an electronic control unit. The electronic control unit calculates corresponding activation signals for an electric drive motor therefrom. The motor torque is converted into a supporting force for the driver with the aid of a multi-stage gear transmission. The force supplied by this booster is converted into hydraulic pressure in a hydraulic piston/cylinder unit for braking. The electromechanical brake pressure generator provides a braking sensation which is comparable to conventional vacuum brake boosters. In this way, the braking sensation may be adapted to brand-specific characteristics of a vehicle with the aid of the electronic control unit using software.

A generic electromechanical brake pressure generator is described in PCT Patent Application No. WO 2017/045804 A1. The brake pressure generator includes an electric drive motor which is operatively connected to a spindle drive unit with the aid of a multi-stage spur gear in such a way that a rotation of the electric drive motor causes a translatory motion of a spindle of the spindle drive unit for actuating a master brake cylinder.

It is an object of the present invention to provide an electromechanically drivable brake pressure generator which is characterized by a lower noise development.

### SUMMARY

The object may be achieved by an electromechanically drivable brake pressure generator for a hydraulic braking system of a vehicle in accordance with the present invention. Advantageous refinements of the present invention are disclosed herein. A vehicle including a hydraulic braking system including the electromechanical brake pressure generator according to the present invention, is also provided.

The present invention includes the technical feature that the spur gear is mounted via a first bearing, which is situated between the spur gear and the planetary gear, and via a second bearing, which is situated on an axial side of the spur gear situated opposite the first bearing.

The spur gear is thus mounted on both sides. In this way, a tilting of the planet carrier axle caused by the load at the spur gear is prevented. As a result of this tilting, the planet wheels in the annulus gear are also normally tilted. As a result, the noise development is greater in the planetary gear since the teeth do not cleanly engage in the annulus gear. Due to the double-sided mounting of the spur gear, this tilting, and the accompanying noise development in the planetary gear, may be considerably reduced.

In one preferred embodiment of the present invention, the planetary gear and the spur gear are situated in a shared housing, opposite which the first and second bearings mount the spur gear. In this way, no additional separate housings must be provided for the bearings. In addition, due to the installation of a shared housing, only one step is required, so that such an electromechanical brake booster is economically manufacturable.

In one further preferred embodiment of the present invention, the housing is attached to a valve housing in which the electric drive motor is accommodated. The housing must be attached to be able to absorb the bearing forces via the housing. Due to the attachment at the valve housing, thus no additional option for attachment must be provided. In addition, the electric drive which drives the planetary gear is also attached to the valve housing, so that the electric drive, the planetary gear, and the bearings have the same reference point. In this way, instances of tilting due to a relative movement at various reference points is avoided, so that the noise development is further improved.

The housing is preferably designed as a deep-drawn part from a metal sheet. The housing is thus manufactured by way of a deep drawing method. Such a deep drawing method has the advantage that the parts manufactured therewith are very cost-effectively manufacturable compared to other, for example machining, methods. This may, in particular, be carried out rapidly in the case of a mass production. The metal sheet additionally provides a sufficient stability for the mounting of the spur gear.

In one advantageous refinement of the present invention, the housing includes a housing recess in the engagement area of the spur gear. Due to the housing recess, which is only provided in the engagement area, on the one hand a sufficient stability for the mounting may be ensured and, on the other hand a torque transmission of the spur gear may be ensured. In this way, a one-piece housing may be provided, which encompasses the spur gear and furthermore also ensures the function of the spur gear.

The diameter of the first bearing is advantageously greater than or equal to a spur gear outside diameter. In the process, diameter of the bearing shall be understood to mean an outside diameter of the bearing. This has the advantage that, due to the arrangement of the components, an installation of an at least first housing is possible after the installation of the spur gear, from one side of the planet carrier axle. This simplifies the installation of the housing. The bearing may also rest directly, i.e., without intermediate pieces, against the housing.

In one further advantageous embodiment of the present invention, the diameter of the second bearing is smaller than a spur gear outside diameter. In the process, diameter of the bearing shall be understood to mean an outside diameter of the bearing. In this way, it is possible to apply at least one housing from one side of the planet carrier axle, which covers the second bearing, the spur gear and, advantageously, the remaining components. This simplifies the installation.

The spur gear is preferably made of a plastic material. A plastic material has the advantage that it has a low weight and is easily manufacturable by way of the injection molding process. A plastic material also has low material costs. In addition, a plastic material may be selected which has good tribological properties, so that self-lubricating plastic materials are usable, by which an additional lubricant could be dispensed with. The spur gear may, for example, be manufactured from polyetheretherketone (PEEK). Accordingly, an electromechanically drivable brake pressure generator may be provided by such a material, which is economically manufacturable.

According to one advantageous embodiment of the present invention, the first bearing and/or the second bearing rest(s) directly against the planet carrier axle, so that the spur gear is mounted via the planet carrier axle. In contrast to a mounting in which the bearings rest against a stage of the spur gear, the spur gear may be designed independently of the bearings, so that the spur gear may be configured in an optimized manner with respect to the actual function.

Exemplary embodiments of the present invention are shown in the figures and are described in greater detail below.

### BRIEF DESCRIPTION OF THE DRAWINGS

FIG. 1 shows a schematic representation of one exemplary embodiment of such a drive train of the electromechanical brake pressure generator according to an example embodiment of the present invention.

FIG. 2 shows a sectional view of a planetary gear including a spur gear according to the related art.

FIG. 3 shows a sectional view of one exemplary embodiment of a planetary gear according to the present invention including a spur gear.

### DETAILED DESCRIPTION OF EXAMPLE EMBODIMENTS

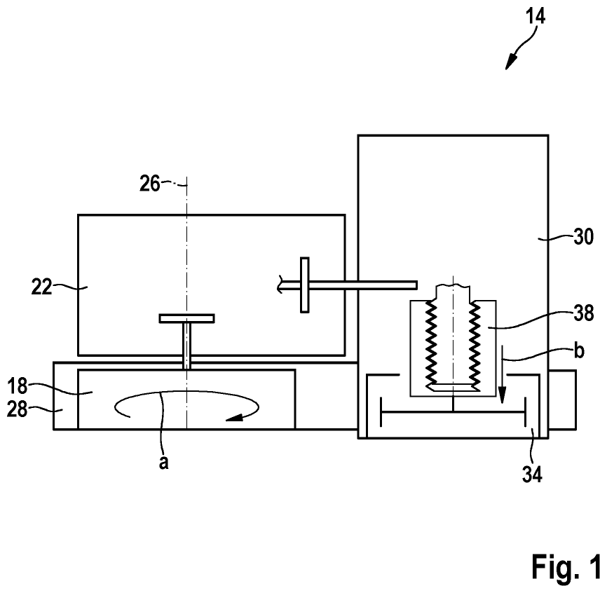

FIG. 1 shows a schematic representation of one exemplary embodiment of such a drive train 14 of an electromechanical brake pressure generator according to the present invention. Drive train 14 includes an electric drive motor 18, with the aid of which a rotary motion a is generatable. Electric drive motor 18 is mechanically connected to an input side of a planetary gear 22. In this exemplary embodiment, planetary gear 22 is coaxially positioned with respect to a drive motor axis 26. Planetary gear 22 is additionally situated at a valve housing 28 of the brake pressure generator.

Via planetary gear 22, the driving rotational speed of electric drive motor 18 is converted into a slower rotational speed. Planetary gear 22 is mechanically connected to a hydraulic module 30 at an output side. Hydraulic module 30 may include a piston/cylinder unit 34, which generates a braking pressure via an axial translatory motion b of a spindle drive unit 38. Drive train 14 shown in this exemplary embodiment is biaxially situated. This means that hydraulic module 30 is situated in parallel to drive motor axis 26.

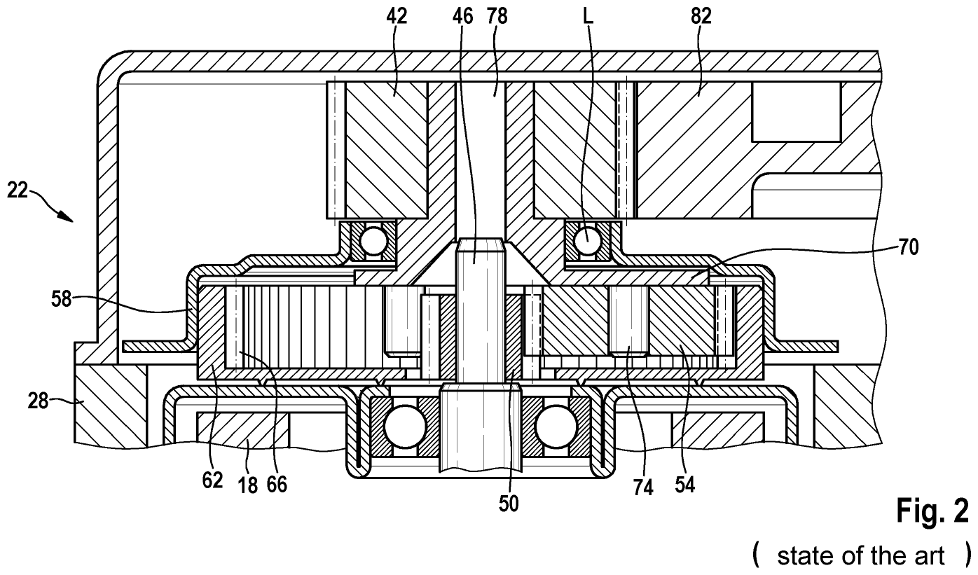

FIG. 2 shows a sectional view of a planetary gear 22 including a spur gear 42 according to the related art. Planetary gear 22 includes a sun wheel axle 46 at which a sun wheel 50 is situated. Sun wheel axle 46 is driven via electric drive motor 18 situated in valve housing 28. Sun wheel 50 is engaged with multiple planet wheels 54 of planetary gear 22. Planet wheels 54 and sun wheel 50 are situated within an annulus gear 62, which is provided in a rotatably fixed manner in a housing 58 of planetary gear 22, so that planet wheels 54 cooperate with internal teeth 66 of annulus gear 62.

Planetary gear 22 additionally includes a planet carrier 70 including planet axes 74 at which planet wheels 54 are rotatably mounted. Planet carrier 70 is rotatably mounted with respect to housing 58 via a bearing L, so that planet carrier 70 is rotatable with respect to the housing with the aid of a rotary motion of planet wheels 54. Planet carrier 70 additionally includes a planet carrier axle 78, at whose end spur gear 42 is fixedly connected to planet carrier axle 78. In the process, spur gear 42 is engaged with a gear wheel 82 of hydraulic module 30.

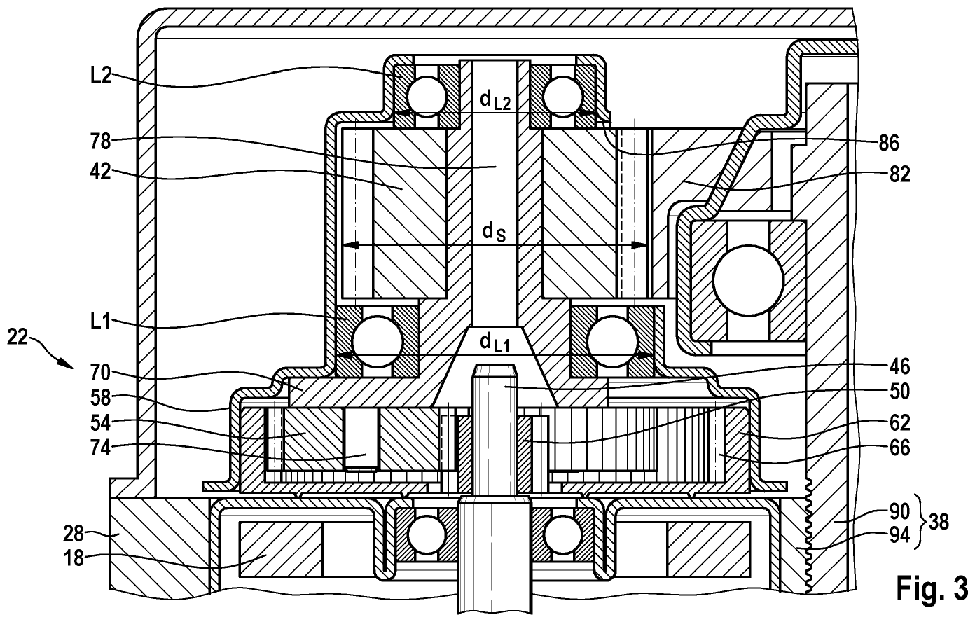

A sectional view of one exemplary embodiment of a planetary gear 22 according to the present invention, including a spur gear 42, is shown in FIG. 3. In this figure, it is apparent that, in addition to first bearing L1 between spur gear 42 and planetary gear 22, a second bearing L2 is situated on planet carrier axle 78. Second bearing L2 is situated at a side of spur gear 42 which is situated axially opposite first bearing L1. In contrast to housing 58 shown in FIG. 2, this housing 58 also surrounds spur gear 42 and second bearing L2. In this way, planet carrier axle 78 may be mounted with respect to housing 58. Housing 58 made up of metal sheet is fixedly connected to valve housing 28 in the process.

Housing 58 is created with the aid of a deep drawing method. In the figure, it is apparent that a diameter d_{L1} of first bearing L1 is greater than a spur gear outside diameter dₛ. Diameter d_{L2} of second bearing L2, in contrast, is smaller than diameter d_{L1} of first bearing L1 and smaller than spur gear outside diameter dₛ. In this way, a deep drawing method of housing 58 and an assembly are made possible at all. To ensure spur gear 42 engages with gear wheel 82 of hydraulic module 30, housing 58 includes a housing recess 86 in the engagement area. This housing recess 86 only has a height of spur gear 42, so that first and second bearings L1, L2 are again in contact with housing 58.

This figure additionally shows a portion of spindle drive unit 38, which includes a spindle 90 and a spindle nut 94, which are engaged with one another.

1-10. (canceled)

11. An electromechanically drivable brake pressure generator for a hydraulic braking system of a vehicle, comprising:
a spindle drive unit configured to convert a drive-side rotary motion into a translatory motion for actuation of a piston of a hydraulic piston/cylinder unit; and
a planetary gear, which is connected to an electric drive motor, situated between the spindle drive unit and an electric drive motor at whose output-side planet carrier axle, a spur gear is attached, via which the spindle drive unit is drivable, wherein the spur gear is mounted via a first bearing, which is situated between the spur gear and the planetary gear, and via a second bearing, which is situated on an axial side of the spur gear which is situated opposite the first bearing.

12. The electromechanically drivable brake pressure generator as recited in claim 11, wherein the planetary gear and the spur gear are situated in a shared housing, opposite which the first and second bearings mount the spur gear.

13. The electromechanically drivable brake pressure generator as recited in claim 12, wherein the housing is attached to a valve housing in which the electric drive motor is accommodated.

14. The electromechanically drivable brake pressure generator as recited in claim 12, wherein the housing is a deep-drawn part made of a metal sheet.

15. The electromechanically drivable brake pressure generator as recited in claim 12, wherein the housing includes a housing recess in an engagement area of the spur gear.

16. The electromechanically drivable brake pressure generator as recited in claim 11, wherein a diameter of the first bearing is greater than or equal to a spur gear outside diameter.

17. The electromechanically drivable brake pressure generator as recited in claim 11, wherein a diameter of the second bearing is smaller than a spur gear outside diameter.

18. The electromechanical brake pressure generator as recited in claim 11, wherein the spur gear is made of a plastic material.

19. The electromechanically drivable brake pressure generator as recited in claim 11, wherein the first bearing and/or the second bearing rests directly against the planet carrier axle so that the spur gear is mounted via the planet carrier axle.

20. A vehicle, comprising an electromechanical brake pressure generator for a hydraulic braking system, the electromechanical brake pressure generator including:
a spindle drive unit configured to convert a drive-side rotary motion into a translatory motion for actuation of a piston of a hydraulic piston/cylinder unit; and
a planetary gear, which is connected to an electric drive motor, situated between the spindle drive unit and an electric drive motor at whose output-side planet carrier axle, a spur gear is attached, via which the spindle drive unit is drivable, wherein the spur gear is mounted via a first bearing, which is situated between the spur gear and the planetary gear, and via a second bearing, which is situated on an axial side of the spur gear which is situated opposite the first bearing.
